(19) United States
(12) Patent Application Publication
(10) Pub. No.: US 2014/0222661 A1
(43) Pub. Date: Aug. 7, 2014

(54) DIGITAL MARKETPLACE FOR RESELLING MEDIA PACKAGES

(71) Applicant: Sony Computer Entertainment America LLC, San Mateo, CA (US)

(72) Inventors: Scott McCarthy, Dublin, CA (US); John Koller, Dublin, CA (US); Jonathan Webb, Sausalito, CA (US)

(73) Assignee: Sony Computer Entertainment America LLC, San Mateo, CA (US)

(21) Appl. No.: 13/791,654

(22) Filed: Mar. 8, 2013

Related U.S. Application Data
(60) Provisional application No. 61/761,001, filed on Feb. 5, 2013.

(51) Int. Cl. G06Q 20/12

(52) U.S. Cl. CPC G06Q 20/1235
USPC 705/39

(57) ABSTRACT

Aspects of the present disclosure describe systems and methods for implementing the sale of a media package that has one or more digital assets and/or platform features and a first level of digital rights management (DRM) protections from a first purchaser to a second purchaser. The DRM protections may limit which digital assets may be sold. The level of DRM protection on the media package may be changed to a second level before being delivered to the second purchaser. The changed DRM protection may restrict the future sale of the digital assets and/or platform feature(s) remaining in the package. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This application is a nonprovisional of U.S. Provisional Patent Application No. 61/761,001, filed Feb. 5, 2013, the entire disclosures of which are incorporated herein by reference.

### FIELD OF THE DISCLOSURE

Aspects of the present disclosure describe systems and methods for establishing a digital marketplace for the sale and resale of media packages. More specifically, the aspects of the present disclosure are related to digital commerce involving reselling media titles that have digital rights management features.

### BACKGROUND OF THE INVENTION

The resale market for used media titles is a profitable industry. For example, the resale market for video games on physical discs has a market value that is approximately twice the size of the primary market for the sale of new video games. Part of the reason the market is so large is that a single physical disc may be resold multiple times on the resale market, whereas the new physical disk may only be sold as new once. On average, in the resale market for video games each disc is resold twice.

Typically, when a media title is distributed on a physical disc the publishing company that produces the media title only generates revenue on the first sale. Thereafter, the publishing company loses the right to intervene in the subsequent resale of the physical disc by the original purchaser. The ability of the publishing company to make additional revenue on the sale of the published media title is therefore extinguished after the first sale. The revenues made in the resale market are predominantly earned by third party facilitators. Third party facilitators may buy a physical disc containing the media title from the original purchaser. The facilitator may then sell the used physical disc to a second purchaser at a price that ensures the facilitator will profit on the transaction. Additionally, the facilitator may be able to re-purchase the disc from the second purchaser and subsequently re-sell the same disc to a third purchaser. Thus, the facilitator can potentially make a profit on the same disc multiple times since the resale process may be repeated one or more times for each physical disc. It is worth not that in this type of market the original purchaser has no say on the trade in value of the disc and that the facilitator sets both the second purchase as well as the second sale price. It is also worth noting that the consumer often uses the used disc market as an alternative economy or wallet, whereby dollars that remain in account can be used for additional purchases including frontline and used games.

In order to regain control of the resale market, publishing companies have made attempts to distribute media titles in alternative formats that may block the resale or transfer of the media title by the original purchaser. Digital rights management (DRM) techniques have been incorporated into both hard and soft copies of distributed media titles. For example, a hard copy, such as a physical disc, may have a DRM incorporated into the software contained on the disc that limits the number of installations that the physical disc may be used for. Alternatively, a soft copy, such as file of the media title downloaded over a network, may have DRM incorporated into the file that prohibits the end user from burning the file to a compact disc or a DVD. The use of DRMs in this manner may reduce the size of the resale market for media titles, but this is not always the optimum outcome for the publishers. It is noted that publishers have attempted to charge an additional amount for playing a second sale disc online (multiplayer).

The use of restrictive technologies that bar the resale or transfer of media titles is often met with harsh backlash from consumers. Additionally, the complete elimination of the resale market may leave potential revenue on the table that could be earned by the publishing companies if they were instead able to participate in and benefit from the resale market. Another issue is that eliminating the resale market can reduce the number of new discs being purchased with funds produced when consumers sell used titles. Consumers often take funds made from selling new discs and purchase more new and used titles.

It is noted that the “publisher” is not the only party that does not benefit from the current marked mode used physical game media. For example, there are a limited number of video game consoles platforms. Publishers often pay these “platform producers” for development and distribution of game titles. In addition, independent “developers” are often paid by “publishers” (and in some cases platform producers) to develop games. Such platform producers and developers currently have no way of benefiting from the secondary market in used game media.

As such, there is a need in the art for systems and methods that provide for a resale marketplace for media titles that is able to provide media publishers and other interested parties with the ability to participate in the resale market and the ability to derive additional revenue from subsequent sales of the media titles that they produced.

It is within this context that aspects of the present disclosure arise.

### BRIEF DESCRIPTION OF THE DRAWINGS

FIG. 1 is a schematic diagram of a client device platform and a digital marketplace server communicating over a network according to an aspect of the present disclosure.

FIG. 2 is a block diagram depicting a media package and digital assets and/or platform features contained within the media package according to an aspect of the present disclosure.

FIG. 3 is a flow diagram of a method for processing a transaction for the sale of a media package over a digital marketplace server according to an aspect of the present disclosure.

FIG. 4 is an example of a table that may be used by the digital marketplace server in order to update and track the level of digital rights management protection for a given media package according to aspects of the present disclosure.

FIG. 5A-5C are examples of media packages that have different levels of digital rights management protection according to aspects of the present disclosure.

FIG. 6 is a block diagram describing the instruction that may be implemented by a digital marketplace server in order to process the sale of a media package between a first and second purchaser according to aspects of the present disclosure.

### SUMMARY OF THE INVENTION

Aspects of the present disclosure describe systems and methods for processing the sale of a media package between a first and second purchaser. The media package may comprise one or more digital assets one or more digital assets and/or platform features that may be included in the sale. The media package may also have a first level of digital rights management (DRM) protections that limit which digital assets in the package may be sold.

A purchase order for the media package may be digitally processed, wherein the media package includes a first level of digital rights management (DRM) protection and one or more digital assets, wherein the package is listed for sale by a first purchaser of the media package and the purchase order is from a second purchaser. The level of DRM protection for the media package may be digitally changed from a first level of DRM protection to a second level of DRM protection. The media title may then be delivered to a device determined by the second purchaser with the level of DRM protection changed from the first level to the second level.

In some implementations, the first purchaser may optionally provide a digital marketplace server with a sale listing that includes a description of the digital assets within the media bundle. The digital marketplace server may then generate a display listing that may be seen by the second purchaser. The second purchaser may deliver the purchase order to the digital marketplace server. The digital marketplace server may then execute the transaction. Additionally, the digital marketplace server may change the level of DRM protection on the media package before it is delivered to the second purchaser. In some implementations, the increased DRM protection may restrict the future sale of the digital assets remaining in the media bundle.

### DETAILED DESCRIPTION OF THE DRAWINGS

Although the following detailed description contains many specific details for the purposes of illustration, anyone of ordinary skill in the art will appreciate that many variations and alterations to the following details are within the scope of the present disclosure. Accordingly, the aspects of the present disclosure described below are set forth without any loss of generality to, and without imposing limitations upon, the claims that follow this description.

As discussed above, the use of restrictive technologies, such as DRM, has been met with significant consumer backlash. Therefore, if restrictive technologies are to be used in the development of a controlled resale market, then it may be desirable to do so in a manner that provides value to the consumers as well. In order to illustrate ways of optimizing the value derived by the consumer, it may be helpful to identify several types of consumers. By way of example, and not by way of limitation, the set of consumers may be broken into categories such as early adopters, volume consumers and low-price consumers.

Early adopters derive value from the ability to consume media soon after it is released. These consumers are typically the first purchasers and are willing to pay the full price of a media title. The next category of consumer, the volume consumer, may derive value from the ability to play many different media titles. With respect to video game titles, each title may be difficult and time consuming to complete. Therefore, a volume consumer may derive value by having features of a game, such as, but not limited to, levels, characters, weapons, and trophies, unlocked. This may save time and allow a volume consumer to play a larger variety of games over given period of time. As such, the volume consumer may be willing to pay a price up to, or even above the original sale price of a media title when the used media title comes packaged with such extra features. In addition consumers are generally price sensitive so it is possible but unlikely that they would pay more than the original sale price of a title. Finally, the low-price consumers may derive value in a media title when it is sold at a low price. So long as the price is low enough, these consumers may find value in the product even when there are few or no additional features bundled with the media title.

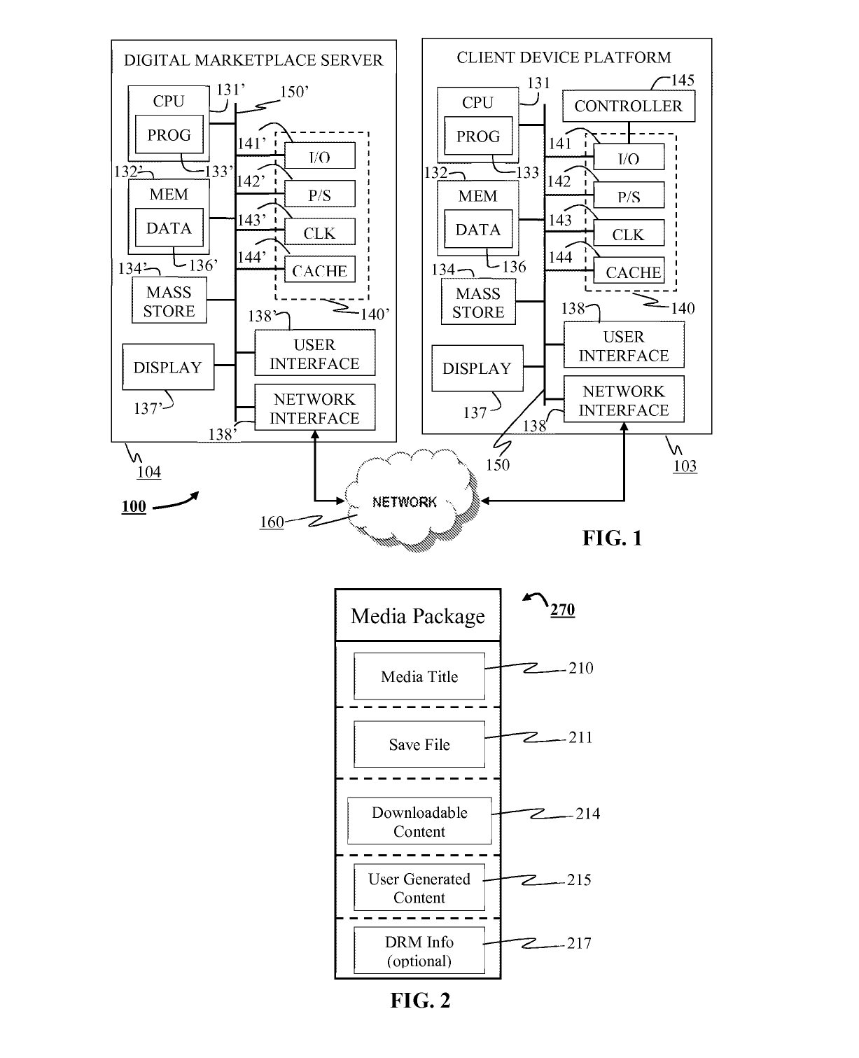

The proposed digital resell market creates the ability to derive additional revenue that that be recycled back into the platform, publisher, developer cycle. FIG. 1 is a schematic of a system 100 according to an aspect of the present disclosure. A digital marketplace server 104 may be accessed by one or more client device platforms 103 over a network 160.

Client device platform 103 may include a central processor unit (CPU) 131. By way of example, the CPU 131 may include a single core or one or more multiple core processors, e.g., a dual-core, quad-core or Cell processors. The client device platform 103 may also include a memory 132 (e.g., RAM, DRAM, ROM, and the like). The CPU 131 may execute a process-control program 133, portions of which may be stored in the memory 132. The client device platform 103 may also include well-known support circuits 140, such as input/output (I/O) circuits 141, power supplies (P/S) 142, a clock (CLK) 143 and cache 144. By way of example, and not by way of limitation, the I/O circuits 141 may include a high-definition multimedia interface (HDMI) connection or a universal serial bus (USB). The client device platform 103 may optionally include a mass storage device 134 such as a disk drive, CD-ROM drive, tape drive, or the like to store programs and/or data. The client device platform 103 may also optionally include (or may be connected to) a display unit 137. The display unit 137 may be in the form of a cathode ray tube (CRT) or flat panel screen such as, but not limited to, a liquid crystal display (LCD), plasma display, light emitted diode (LED) display, or an organic light emitted diode (OLED) display. The display unit 137 may be configured to display text, numerals, graphical symbols, still images, or video images.

A controller 145 may be connected to the client device platform 103 through the I/O circuit 141 or it may be directly integrated into the client device platform 103. The controller 145 may facilitate interaction between the client device platform 103 and a user. The controller 145 may include a keyboard, mouse, joystick, light pen, touch pad, touch screen, hand-held controller (e.g., game controller) or other device.

The client device platform 103 may include a network interface 139, configured to with other devices via an electronic communications network 160. The network interface 139 may enable the use of Wi-Fi, an Ethernet port, or other communication methods. The network interface 139 may incorporate suitable hardware, software, firmware or some combination of two or more of these to facilitate communication. The network interface 139 may be configured to implement wired or wireless communication over local area networks and wide area networks such as the Internet. The client device platform 103 may send and receive data and/or requests for files via one or more data packets over the network 160.

The preceding components may exchange signals with each other via an internal system bus 150. The client device platform 103 may be a general purpose computer that becomes a special purpose computer when running code that implements embodiments of the present invention as described herein. By way of example, and not by way of limitation, the client device platform 103 may be a gaming console, a personal computer, a tablet computer, a smart phone, or other similar devices.

The digital marketplace server 104 may include a central processor unit (CPU) 131′. By way of example, a CPU 131′ may include one or more processors, e.g., a dual-core, quad-core or Cell processor. The digital marketplace server 104 may also include a memory 132′ (e.g., RAM, DRAM, ROM, and the like). The CPU 131′ may execute a process-control program 133′, portions of which may be stored in the memory 132′. The digital marketplace server 104 may also include well-known support circuits 140′, such as input/output (I/O) circuits 141′, power supplies (P/S) 142′, a clock (CLK) 143′ and cache 144′. By way of example, and not by way of limitation, the I/O circuits 141′ may include a high-definition multimedia interface (HDMI) connection or a universal serial bus (USB). The digital marketplace server 104 may optionally include a mass storage device 134′ such as a disk drive, CD-ROM drive, tape drive, or the like to store programs and/or data. The digital marketplace server 104 may also optionally include a display unit 137′ and user interface unit 138′ to facilitate interaction between the digital marketplace server 104 and a user who requires direct access to the digital marketplace server 104. The display unit 137′ may be in the form of a cathode ray tube (CRT) or flat panel screen such as, but not limited to, an LCD, plasma, LED, or an OLED that displays text, numerals, or graphical symbols. The user interface unit 138′ may include a keyboard, mouse, joystick, light pen, or other device. The digital marketplace server 104 may include a network interface 139′, configured to enable the use of Wi-Fi, an Ethernet port, or other communication methods.

The network interface 139′ may incorporate suitable hardware, software, firmware or some combination of two or more of these to facilitate communication via the electronic communications network 160. The network interface 139′ may be configured to implement wired or wireless communication over local area networks and wide area networks such as the Internet. The digital marketplace server 104 may send and receive data and/or requests for files via one or more data packets over the network 160.

The above-described components of the digital market placer server 104 may exchange signals with each other via an internal system bus 150′. The digital marketplace server 104 may be a general purpose computer that becomes a special purpose computer when running code that implements embodiments of the present invention as described herein. By way of example, and not by way of limitation, the digital marketplace server 104 may be implemented on a cloud based server such as, but not limited to an Amazon Elastic Compute Cloud available from Amazon Web Services. In implementation of particular interest, the server 104 may direct traffic to a network of servers associated with a producer of the client device platform 103. By way of example, producers of certain game console platforms, such as PlayStation Platforms from Sony Computer Entertainment, have established networks of servers that manage online games that are played through such client device platforms. In such implementations, the digital transaction may be self-contained on the platform producer's network (i.e., not available for transaction with other services).

It is noted that the foregoing description of the digital marketplace server is for illustrative purposes and is not to be taken as a limitation on aspects of the present disclosure. Specifically, although it may be convenient to envision the server function as being implemented on dedicated hardware, such hardware should not be confused with the function of the marketplace server 104. This function may be implemented by one or more pieces of hardware that implement the server function through execution of suitably configured software code in conjunction with suitable data. More specifically, in the context of client-server architecture, the marketplace server 104 may be implemented as a computer program running to serve the requests of other programs, the “clients”. The clients either run on the same hardware as the marketplace server 104, or the server and clients may be implemented on different pieces of hardware that connect through a network.

According to aspects of the present disclosure, the digital marketplace server 104 may be configured to implement a centralized location where a plurality of visitors may interact with each other through client device platforms, line the client device platform 103. By way of example, and not by way of limitation, visitors may include publishers and purchasers. A publisher may be an individual or an organization that produces media titles and offers them for sale to other visitors to the digital marketplace server 104. A publisher may be the owner of the digital marketplace server 104, or the owner of the digital marketplace server 104 may grant the publisher permission to use the digital marketplace server 104 in order to sell their media titles. The other visitors to the digital marketplace server 104, such as the purchasers, may be media title consumers who desire to purchase and/or resell the media titles produced by a publisher.

Each of the visitors may have generated user profiles in order to gain access to the digital marketplace server 104. The actions of the each visitor on the digital marketplace server 104 may be recorded to the visitor's user profile. As such, each visitor may access the digital marketplace server 104 from different client device platforms 103. By way of example, and not by way of limitation, a visitor may access the digital marketplace server 104 through a gaming device such as a PlayStation 3, or a PlayStation Vita, both available from Sony Computer Entertainment, or alternatively through a smart phone via a mobile application. Additionally, more than one visitor may access the digital marketplace server 104 from any single client device platform 103 since each visitor may be associated with a unique user profile. By way of example, and not by way of limitation, a visitor may login to the digital marketplace server 104 via his personal PlayStation 3, and thereafter, a second visitor may use the same PlayStation 3 as an access point into the digital marketplace server 104 by using his own login account.

FIG. 2 is a depiction of a media package 270 according to an aspect of the present disclosure. Media package 270 may include one or more digital assets and/or one or more platform features. The term platform features is used to refer to digital content that is particular to a given type of client device platform (e.g., a particular brand of game console device) but which is not specific to a particular media title. The full scope of one or more digital assets and/or one or more platform features includes those assets that pertain to one title only in addition to platform features that can be added or removed via the DRM, such as cloud based access to different console devices.

By way of example, and not by way of limitation, a media package may include one full game title with digital only-features. By way of further example, and not by way of limitation, a digital asset may be a media title 210, a save file 211, downloadable content (DLC) 214, and user generated content 215. By way of example, and not by way of limitation, a media title 210 may be a video game, a movie, an audio recording, a compilation of two or more video games, movies, or audio recordings, or any combination thereof. By way of example, a save file 211 may be the saved progress an end user has made in a given media title 210, such as, but not limited to advancement through one or more levels in a video game, or promotion of any character that can gain playable experience to a higher ranking in the game. By way of example, and not by way of limitation, DLC 214 may be additional portions of a media title 210 that are sold separate from the original purchase, such as but not limited to, additional level maps, weapons, characters, or storylines. By way of example, and not by way of limitation, user generated content 215 may be a new map generated by an end user that may be used in conjunction with the media title 210, or designing a new avatar that may be utilized within the media title 210. As described herein, the digital assets such as the save file 211, the DLC 214, and the user generated content 215 are described as distinct assets, but it should be noted that the DLC 214 and the user generated content 215 may also optionally be incorporated into the save file 211.

The aforementioned features are among those that can be added to the DRM by the first purchase consumer. Additional features provided by the platform to the frontline title are also important features. Such additional features include the ability to access purchased content from any console device though a digital ID. By way of example, a digital ID may be a user name with password. Additional features may also include incentives available from a platform producer, such as experience boosts, additional characters, weapons and levels online play with no additional access fee.

When a media package 270 is initially sold to a first purchaser, it may have a first level of digital rights management (DRM) protection. The first level of DRM protection should preferably be the least restrictive level of DRM protection. By way of example, and not by way of limitation, the first level of DRM protection may prevent the production of pirated copies of the media title 210, and may also include the right to resell the media package 270, and all of the digital assets and/or platform features added to the media package 270, through the digital marketplace server 104. Additionally, every level of DRM protection may prevent the transfer of the media package 270 to take place outside of the digital marketplace server.

There are a number of different ways of implementing DRM. By way of example, and not by way of limitation, authentication of DRM may take place at the server (not the platform) level if this is where any transaction or ownership transfer takes place. However, in the context of games, authentication of the DRM for general play sessions may take place at the system level. Therefore, DRM authentication can be flexible and need not be relegated to the server or device level. In some implementations that are currently envisioned, consumers would not need to authenticate per gameplay session but would need to authenticate in order to list a title for sale. Authentication data may be included within the digital asset and/or platform feature sold though so as to keep the correct level of DRM through the purchase cycle.

A first level of DRM protection such as this is preferable because it will entice early adopters to make the initial purchase because in addition to having the game first, they may also be able to recoup some of their investment by reselling the media package 270 through the digital resale marketplace server 104. Additionally, it may even be possible for the first purchaser to resell the media package 270 at a price above the original purchase price since the first level of DRM protection may allow the resale of all of the digital assets and/or platform features in the media package 270, including assets not present in the package when it was first purchased.

According to certain aspects of the present disclosure, changing the DRM level on the media package 270 prevents a purchaser from re-selling the same package more than once for the same DRM level. Also, in some implementations after the sale the seller would lose all ability to use the media title. To implement this, the DRM may be removed from either the original purchaser's hard drive or cloud based access point upon completion of the transaction.

The behavior of the transactions envisioned in aspects of the present disclosure may be thought of as a digital equivalent of selling a used physical game disc to another consumer though e-bay. The difference is that degradation of a ‘used digital product’ is represented by removing features associated with the digital product that could be associated with all products. The benefits that remain on the game are digital benefits that were ‘created’ by the original owner. By way of analogy, when a consumer buys a new car, it becomes less valuable the minute it is driven off the lot. If the consumer upgrades the car enough it can be re-sold to a new user for more than the original price. However this may only be likely if the upgrades are unique in nature and unlike other used cars of the same make. Continuing the analogy, when the consumer sells the car, the consumer no longer has access to it. Aspects of the present disclosure allow for different types of digital assets and/or platform features to be sold, thus the same asset could be sold at differing price points based on what is included with sale (e.g., extra DLC, and the like.).

For example, in many media titles 210 there are missions or levels that need to be completed before bonus material is provided to the end user. If the first purchaser has already unlocked all of the bonus material, then the save file 211 may be considered valuable to some potential purchasers. Additionally, the acquisition of DLC 214 may increase the value of the media package 210 because the next purchaser will not have to expend resources to acquire the DLC 214 a second time. Finally, a first purchaser may be skilled at developing user generated content 215 that may be desired by subsequent purchasers. When these types of digital assets are also included in the sale of the media package 270 then a subsequent purchaser, such as the volume consumer described above, may pay a premium on the original purchase price. Presently, the additional digital assets, such as the save file 211, the DLC 214, and the user generated content 215 are typically not sold along with the media title at the brick and mortar retailers who resell the used physical discs. Knowing that they may be able to recoup a portion of their purchase price through the resale (or even resell the game at a profit) provides a desirable benefit for purchasers who may fall into the early adopter category of consumers.

To facilitate change of levels of DRM protection, the media package 270 may optionally include DRM information 217. The DRM information may be in the form of digitally stored data that identifies the level of DRM protection associated with the media package 270. Alternatively, the DRM information 217 may include a unique identifier for the particular media bundle. The unique identifier may be configured so that a remote server may determine the appropriate level of DRM protection for the media package 270 from the unique identifier.

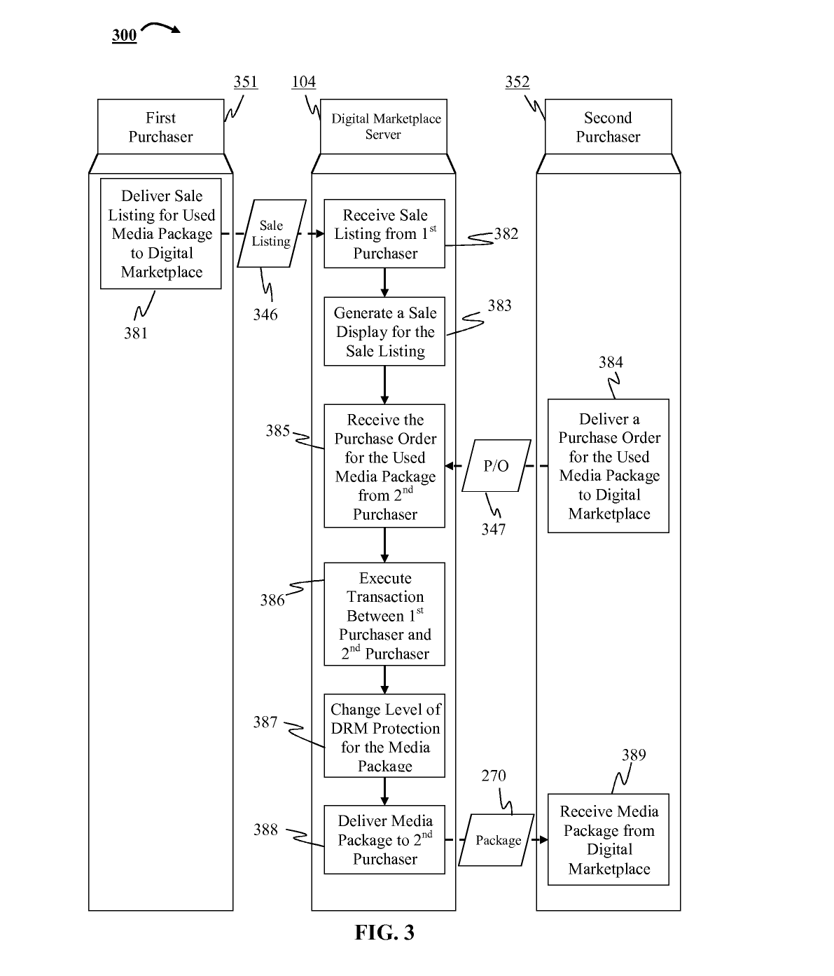

FIG. 3 is a flow diagram of a method 300 for processing the sale of a media package on a digital marketplace server 104 according to aspects of the present disclosure. The dotted arrows represent data being delivered over the network 160. Rectangular boxes represent processing steps, and the parallelograms represent the various forms of data being transferred. The first purchaser 351 shown in FIG. 3 may own a media package 270. By way of example, the first purchaser 351 may have bought the media package new, e.g., from a publisher or platform producer. Alternatively, the first purchaser may have bought the media package as used from another purchaser, so long as the level of DRM protection incorporated into the media package has not been already increased to a level that restricts resale.

Initially, the first purchaser 351 first may deliver a sale listing 346 to the digital marketplace server 104 over the network 160 at box 381. A sale listing 346 may include information that describes the media package 270. Preferably, the information included in the sale listing 346 should describe the media package 270 in as much detail as possible. This is preferable because even though the media title 210 within the package may be the same as when it was originally sold by the publisher, the additional digital assets added to the media package 270 by the first purchaser 351, such as the DLC, user generated content, and save file (if they are permitted to be resold under the given level of DRM protection), may vary greatly between packages.

By way of example, and not by way of limitation, the sale listing 346 may comprise a written description of the digital assets included in the media bundle, pictures of the game play that display achievements earned or user generated content, statistics stored in the save file, a video overview of the package, or any similar disclosures, or any combination thereof. A video overview of the package may be easily produced by the first purchaser with the use of an optional share button. In some implementations, the share button may be optionally incorporated into a controller 145 on the client device platform used by the first purchaser. When the share button has been pressed on relevant consoles, the previous audio and video stream displayed by the client device platform 103 over the past few minutes is saved as a video file. As such, the first purchaser 351 may create a virtual tour of the media package and then save the tour for use in the sale listing 346. The video file itself may be provided as part of the sale listing 346, or a link to its location on a video sharing website, such as YouTube, may be provided as part of the sale listing 346. The use of a share button to create video clips is described in detail in commonly owned U.S. patent application Ser. No. 13/418,720, entitled “SYSTEM AND METHOD FOR CAPTURING AND SHARING CONSOLE GAMING DATA”, to Nathan Gary, filed Mar. 13, 2012, which is incorporated herein by reference in its entirety.

Additionally, the sale listing 346 may include an asking price for the media bundle. According to additional aspects of the present disclosure, the sale listing 346 may also include instructions directing the digital market place server 104 to sell the media package 270 in an auction setting. When an auction setting is chosen for the sale of the media package 270, then the sale listing 346 may also include a minimum bid, and the length of time the auction will last.

The digital market place server 104 may receive the sale listing 346 from the first purchaser 351 at 382. The digital marketplace server 104 may then generate a sale display from the information included in the sale listing 346 at 383. It is noted that the seller, (i.e., the first purchaser in this example) may set the sale price in the sale listing. By way of example, and not by way of limitation, the sale display may be an advertisement that presents any pictures, video, or text that was provided in the sale listing, including, e.g., the sale price. According to aspects of the present disclosure that utilize an auction setting, the sale display may also include mechanisms, such as, but not limited to, buttons and fields that allow visitors to place bids on the media package. Additionally, the sale display may also list the restrictions on the media package 270 that are enforced by the increased level of DRM protection subsequent to the purchase.

The sale display is visible to visitors of the digital marketplace server 104, such as the second purchaser 352. By way of example, and not by way of limitation, the sale display may be included in a searchable database that stores all sale displays for media packages currently being sold. Additionally, the digital marketplace server 104 may generate a URL that may direct visitors directly to the sale display. The first purchaser 351 may share the URL in order to increase the chances that a prospective purchaser sees the sale display. By way of example, and not by way of limitation, the sale display may be shared by posting the URL on a social media site, such as, but not limited to, Facebook, Twitter, or Google+ and YouTube or any other social media asset aggregator.

When a second purchaser 352 decides to purchase the media package 270 being advertised in the sale display, he may deliver a purchase order 347 to the digital marketplace server 104 at 384. By way of example and not by way of limitation, the purchase order 347 may be a data packet delivered to the digital marketplace server 104 over the network. The data packet may be automatically generated when the second purchaser interacts with the sale display in a predetermined manner. By way of example, and not by way of limitation, the predetermined manner may be pressing a button on the display that, when pressed, indicates assent to the purchase. Alternatively, the predetermined manner may be winning the auction, when the first purchaser chooses to sell the media package 270 through an auction.

The digital marketplace server 104 may receive the purchase order 347 at 385. Then, at 386 the digital marketplace server 104 may execute the transaction between the first purchaser 351 and the second purchaser 352. The digital marketplace server 104 may execute the transaction by debiting an account associated with the second purchaser 352 the price of the media package 270 that was purchased. By way of example, the price may be measured in real currency or in a digital currency such as credits. The digital marketplace server 104 may then divide the payment between one or more parties, such as the first purchaser 351, the publisher of the media title 210 that is in the media package 270, and the owner of the digital marketplace server 104. By way of example, and not by way of limitation, a first portion of the payment may be provided to the first purchaser 351, a second portion of the payment may be provided to the publisher, and a third portion of the payment may be provided to the owner of the digital marketplace server 104. By limiting the resale of the media package 270 to only being executed over the digital marketplace server 104, the publisher of the media title 210 is capable of receiving a portion of the resale value that otherwise would be earned only by the brick and mortar stores that presently sell the used physical discs.

Once the transaction has been executed, the digital marketplace server 104 may change the level of DRM protection for the media package 270 at 387. In principle, the level of protection may either increase or decrease. In certain implementations, it may be desirable to increase the level of DRM protection for the media package 270 each time with each sale of the media package following its first sale to a user. By way of example, and not by way of limitation, the digital marketplace server 104 may increase the level of DRM protection by updating a database that stores information regarding the ownership of a media 270 package and the rights conferred to the visitor who owns that media package 270. The digital marketplace server 104 may optionally change the DRM information 217 to reflect the changed level of DRM protection.

In certain implementations, the digital marketplace server 104 may receive the media package 270 from the first purchaser as part of the transaction at 386. After changing the DRM level, the digital marketplace server may then deliver the media package to the second purchaser in “used” form, i.e., with a changed level of DRM. This process may be repeated for subsequent re-sale of the media package 270.

By way of example this sort of database may be similar to database 400 shown in FIG. 4. Unique package identifiers (IDs) 405 are listed for each media package 270 that has been purchased over the digital marketplace 104 in the first column of database 400. The boxes in the rows next to each package ID 405 indicate the login identifier or profile name 406 of the visitor who purchased the media package identified by the package ID 405 in the first column. In order to determine who owns the rights to a specified media package 270, the digital marketplace server 104 looks to see which login identifier is in the furthest right column. Once the identity 406 of the visitor who owns the rights to the media package is determined, the level of DRM protection is determined by looking at the title of the column the visitor is listed under. By way of example, in FIG. 4 the owner of the rights to media package “ABC” is visitor number “157623”, and that visitor has the rights granted by the second level of DRM protection. When the digital marketplace server 104 updates the database 400 it may enter a new entry into the column immediately to the right of the last column in the row for the designated media package 270.

After the digital marketplace server 104 has increased the DRM protection for the media package 270, a digital copy of the media package may be delivered to the second purchaser 352 over the network 160 at 388. The second purchaser 352 may then receive the media package 270 at 389. By way of example, the second purchaser 352 may receive the media package 270 by having the copy downloaded to a designated client device platform 103. This may be beneficial because the second purchaser could have accessed the digital marketplace server 104 from any number of client device platforms 103. For example, the second purchaser 352 may have used a smart phone to access the digital marketplace server, but desired the media package to be delivered to a gaming console located at his home. According to additional aspects of the present disclosure, the second purchaser 352 may have purchased the media package 270 as a gift for third-party visitor not involved in the financial transaction. In these circumstances, the third-party visitor's login account information may be recorded in table 400 as the owner when the DRM level is increased at step 387. The digital marketplace may then notify the third-party visitor that there is a media package 270 that they are able to download to their preferred client device platform 103.

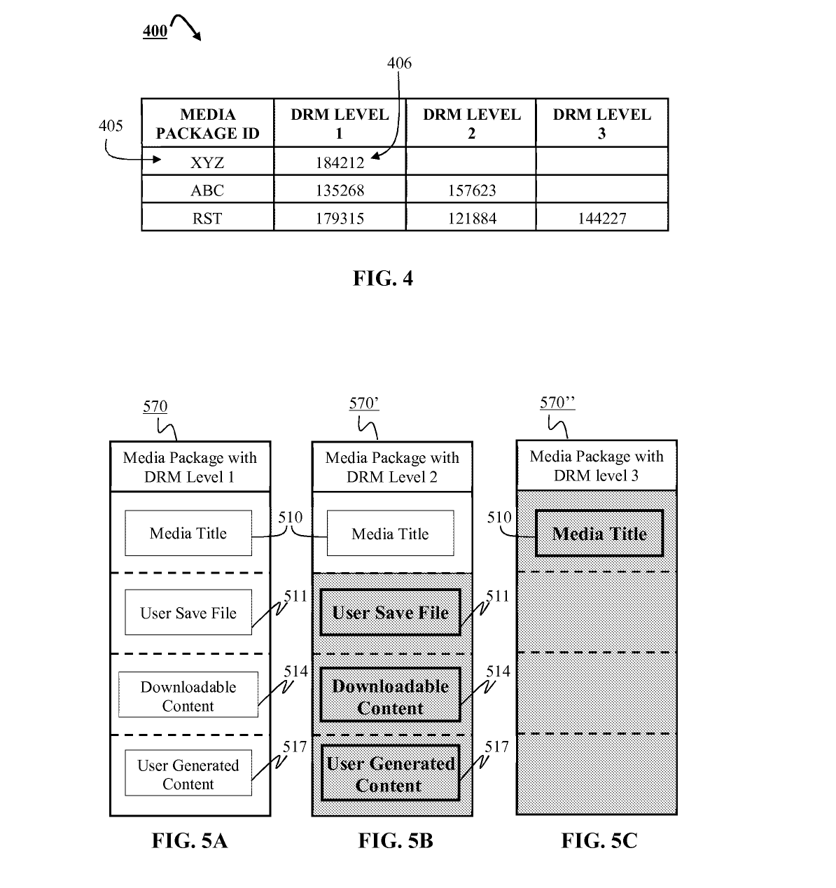

According to additional aspects of the present disclosure, a single media package 270 may be purchased and resold one or more times. FIGS. 5A-5C show a media package at various levels of DRM protection. While a three-tiered system is described in detail, the disclosure should not be limited as such. Additionally, the DRM protections described in detail relate to the resale rights of the media package 570, but the disclosure should not be limited as such. By way of example, the DRM protections may also include limits on the number of installations, how often data may be saved, or any other feature that adds value to the media bundle.

FIG. 5A is a media package 570 that has been owned and used by a first purchaser. Under the first level of DRM protection, the first purchaser may have the right to resell all of the digital assets that came with the original media package 570, or that were added during the use of the media package 570. By way of example, media package 570 may comprise the media title 510, the save file 511, the DLC 514, and user generated content 517.

Next, FIG. 5B depicts a media package 570′. Media package 570′ is the media package that is delivered to the second purchaser after purchasing media package 570 from the first purchaser over the digital marketplace server 104. The DRM protection level was increased during the transfer of the media package 570 from the first purchaser to the second purchaser. As indicated by the shaded regions, the DRM protections may now only allow the media title 510 to be resold with the media package 570′. The additional digital assets that are covered by the shaded region are no longer transferable. However, it should be noted that the second purchaser may still utilize the save file 511, the DLC 514, and the user generated content 517 before the media package 570 is resold. In certain implementations, the second purchaser may not use certain additional features, such as the ability to access purchased content from any console device though a digital ID, incentives available from a platform producer, such as experience boosts, additional characters, weapons and levels online play with no additional access fee, or cloud based access across multiple console devices. Additionally, the second purchaser may be able to acquire additional DLC 514, produce his own user generated content 517, and add new information to the save file 511, but it should be noted that even these newly produced digital assets are also not transferable under the new level of DRM protection for the media package 570′. It should be noted that these limitations to the second purchaser are by way of example and not limitations. For example, in certain implementations the second purchaser may be allowed to add DLC and be able to sell this with the media package 570.

Finally, FIG. 5C depicts the media package 570″. Media package 570″ is the media package that is delivered to the third purchaser after purchasing media package 570′ from the second purchaser through the digital marketplace server 104. According to this aspect of the present disclosure, the DRM protection level may be increased to the point where future transfers of the media package are no longer allowed. The media package is now completely shaded in, and there are no digital assets remaining that may be resold by the third purchaser. The third purchaser may only play the media title 510 that was included in the media package he purchases. While the third purchaser may not be allowed to resell the digital assets in the media package any further, the third purchaser may still be optionally allowed to generate a new save file, acquire his own DLC, or generate his own user generated content.

According to additional aspects of the present disclosure, a third purchaser may be able to reset the DRM protections to the first level if he desires to resell the media package 570 an additional time. This may be beneficial if the third purchaser is able to produce content (either through his own user generated content 517, or through the generation of a valuable save file 511) that may be marketable. In such situations, the third purchaser may enter into a transaction with the publisher over the digital marketplace 104 for the renewal of the DRM rights. By way of example, the publisher may require that the third party purchaser rebuy the rights for a cost approximately equal to the price of buying a new media package containing the same media title.

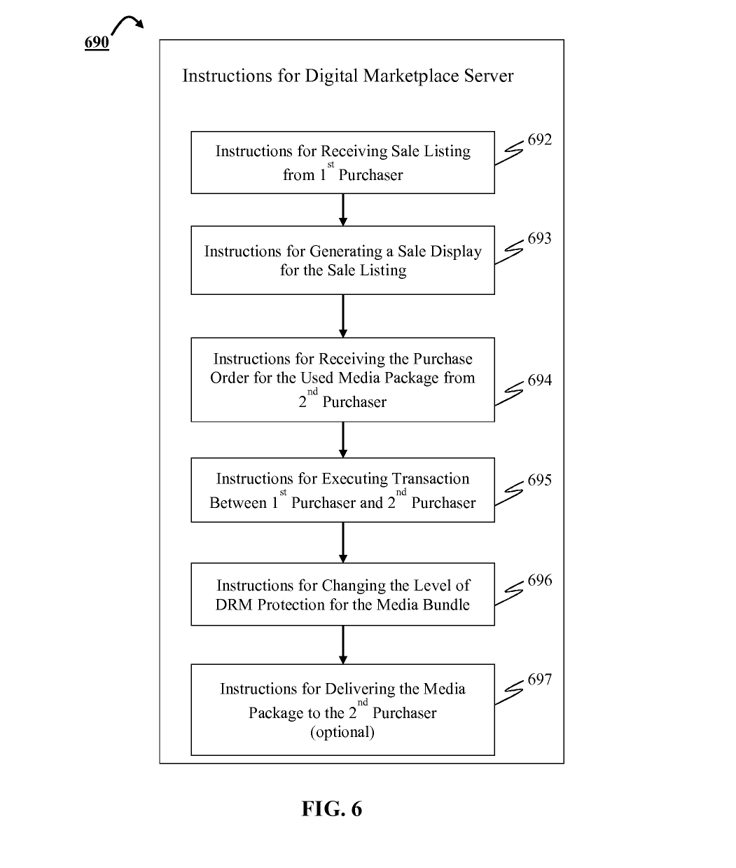

As shown in FIG. 6, a set of digital marketplace server instructions 690 may be implemented, e.g., by the digital marketplace server 104. The digital marketplace server instructions 690 may be formed on a nontransitory computer readable medium such as the memory 132′ or the mass storage device 134′. The digital marketplace server instructions 690 may also be part of the process control program 133′. As indicated at 692 the digital marketplace server instructions 690 may include instructions for receiving a sale listing from the first purchaser. As indicated at 693, the digital marketplace server 104 may be provided with instructions for generating a sale display from the information in the sale listing. The digital marketplace server instructions 690 may further include instructions for receiving a purchase order from a second purchaser as indicated at 694. Upon receipt of the purchase order, the instructions may also include executing the transaction between the first and second purchasers as indicated at 695. The digital marketplace server 104 may then be instructed to change the level of DRM protection on the media package as indicated at 696. Thereafter, the instructions 690 may instruct the digital marketplace to deliver the media package to the second purchaser, as indicated at 697.

Aspects of the present disclosure allow for a resale marketplace for media titles that provides media publishers, platform producers, and other interested parties with an ability to participate in the resale market for digital media titles and an ability to derive additional revenue from subsequent sales of the media titles that they produced.

It is noted that aspects of the present disclosure are not limited by where the consumer downloads the content (e.g., to a hard drive or portable memory storage). Aspects of the present disclosure also include implementations in which content is downloaded to remote storage, such as cloud-based storage.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A nontransitory computer readable medium containing computer-executable program instructions wherein the instructions are configured such that execution of the program instructions by one or more processors of a computer system causes the one or more processors to implement a method, the method comprising:
a) digitally processing a purchase order for a media package, wherein the media package includes a first level of digital rights management (DRM) protection and one or more digital assets and/or platform features, wherein the package is listed for sale by a first purchaser of the media package and the purchase order is from a second purchaser;
b) digitally changing a level of DRM protection for the media package from a first level of DRM protection to a second level of DRM protection; and
c) digitally delivering the media title to a device determined by the second purchaser with the level of DRM protection changed from the first level to the second level.

2. The nontransitory computer readable medium of claim 1, wherein the first level of DRM protection permits the first purchaser to sell the complete set of the one or more digital assets and/or platform feature(s) in the media bundle.

3. The nontransitory computer readable medium of claim 2, wherein one of the one or more assets is a media title.

4. The nontransitory computer readable medium of claim 3, wherein the media title is a video game.

5. The nontransitory computer readable medium of claim 4, wherein the one or more digital assets further comprise a save file, downloadable content (DLC), and user generated content and/or platform feature(s).

6. The nontransitory computer readable medium of claim 2, further comprising receiving a sale listing for the media package from the first purchaser.

7. The nontransitory computer readable medium of claim 6 wherein the sale listing comprises a description of the one or more digital assets.

8. The nontransitory computer readable medium of claim 7, wherein the description of the one or more digital assets is a written description.

9. The nontransitory computer readable medium of claim 7, wherein the description of the one or more digital assets includes a video.

10. The nontransitory computer readable medium of claim 7, wherein the video is made with a share button.

11. The nontransitory computer readable medium of claim 7, wherein the sale listing further comprises a selling price for the media bundle.

12. The nontransitory computer readable medium of claim 2, wherein the second level of DRM protection only permits the second purchaser to sell less than the entire set of the one or more digital assets in the media bundle.

13. The nontransitory computer readable medium of claim 12, wherein the second level of DRM protection permits the second purchaser to sell only one of the one or more digital assets in the media package.

14. The nontransitory computer readable medium of claim 12, wherein the one digital asset that may be sold is a media title.

15. The nontransitory computer readable medium of claim 1, wherein the first level of DRM protection permits the first purchaser to sell less than the entire set of the one or more digital assets in the media bundle.

16. The nontransitory computer readable medium of claim 15, wherein the first level of DRM protection permits the first purchaser to sell only one of the one or more digital assets in the media bundle.

17. The nontransitory computer readable medium of claim 16, wherein the one digital asset that may be sold is a media title.

18. The nontransitory computer readable medium of claim 15, wherein the second level of DRM protection prevents the second purchaser from selling any of the one or more digital assets in the media bundle.

19. The nontransitory computer readable medium of claim 1, where the method further comprises generating a sale display for the media package that is displayed in the digital marketplace.

20. The nontransitory computer readable medium of claim 19 wherein generating the sale display comprises transforming information included in the sale listing into a viewable format.

21. The nontransitory computer readable medium of claim 20, wherein the viewable format is webpage located at a URL

22. The nontransitory computer readable medium of claim 21, wherein the URL is posted on social media sites.

23. The nontransitory computer readable medium of claim 1, wherein digitally processing the purchase order further comprises:
receiving a payment from the second purchaser;
providing the first purchaser with a first portion of the payment; and
retaining a second portion of the payment as a transaction fee.

24. The nontransitory computer readable medium of claim 23, further comprising, providing a third portion of the payment to a publisher who originally produced the media bundle.

25. A digital marketplace server configured to operate on a network, comprising:
a processor;
a memory coupled to the processor;
one or more instructions embodied in memory for execution by the processor, the instructions being configured to implement a method, the method comprising:
a) digitally processing a purchase order for a media bundle, wherein the media package includes a first level of digital rights management (DRM) protection and one or more digital assets and/or one or more platform features, wherein the package is listed for sale by a first purchaser of the media package and the purchase order is from a second purchaser;
b) digitally changing a level of DRM protection for the media package from a first level of DRM protection to a second level of DRM protection; and
c) digitally delivering the media title to a device determined by the second purchaser with the level of DRM protection changed from the first level to the second level.

26. A method comprising:
a) digitally processing a purchase order for a media bundle, wherein the media package includes a first level of digital rights management (DRM) protection and one or more digital assets and/or one or more platform features, wherein the package is listed for sale by a first purchaser of the media package and the purchase order is from a second purchaser;
b) digitally changing a level of DRM protection for the media package from a first level of DRM protection to a second level of DRM protection; and
c) digitally delivering the media title to a device determined by the second purchaser with the level of DRM protection changed from the first level to the second level.
